(19) United States
(12) Patent Application Publication
(10) Pub. No.: US 2003/0012014 A1
(43) Pub. Date: Jan. 16, 2003

(54) Structure of a bed lamp

(76) Inventor: Shun-Feng Huang, Feng-Yuan City (TW)

Correspondence Address: SHUN-FENG HUANG, P.O. Box 697, Feng-Yuan City, 420, TW

(21) Appl. No.: 09/904,250

(22) Filed: Jul. 10, 2001

(51) Int. Cl. F21V 9/12

(52) U.S. Cl. 362/101; 362/318; 362/294; 362/242

(57) ABSTRACT

A structure of a bed lamp includes a transparent tube containing of the colored water and having an opening in bottom secured by a circular metal vase and wrapped by a rubber sleeve, a shade having an upper part including a protrudent central bore to engage with the vase and partial transparent tube and a lower part releasably engaged with the upper part including a central bore in bottom for disposing a base of an electric bulb, and a plurality of air vents spacedly formed around the body of the shade. The bed lamp of the present invention may connect to a wall socket or a socket from a string of Christmas lights.

### BACKGROUND OF THE INVENTION

The present invention relates to lamps and more particularly to a structure of a bed lamp which is durable and reliable and readily to manufacture.

Typical bed lamp 10 (as shown in FIG. 1) comprises a glass tube 11 and a shade 12. The glass tube 11 contains sand 111 and colored water 112. The shade 12 includes an upper portion 121 adhered to a lower portion 122 and a bulb disposed inside the shade and engaged to the glass tube 11. When the bulb is lightened, the heat from the bulb warms the sand 111 and the colored water 112 which creates the bubbles from the bottom to the top. However, this type of bed lamp 10 has the following disadvantages:

a) the heating speed is rather slow for several minutes, if in cold weather, the heating speed will be more slow,

b) the sand and the water pours into the glass tube and then seals up the tube this process is rather complicated and the failure rate is rather high,

c) when the bulb is burned out, it could not change a new one because of that the shade is not disengageable, and

d) if the bottom of the glass tube disengages with the bulb because of the manufacture error the heating speed shall be more slow.

### SUMMARY OF THE PRESENT INVENTION

The structure of a bed lamp of the present invention comprises a transparent tube having an opening in the bottom for pouring in the color water, a circular metal vase containing the sand therein and having a reduced upper portion engaged with the opening of the transparent tube and connected with adhesives, a rubber sleeve wrapped on the bottom of the tube and the vase and a shade having an electric bulb disposed therein. The shade includes an upper portion and a lower portion releasably engaged together. The upper portion has a central bore on the top to engage with the vase and tube, a plurality of air vents spacedly formed around the body and a threaded on outer rim. The lower portion has also a central bore in bottom, a thread on the inner rim and a plurality of air vents spacedly formed around the body. Therefore the bulb warms the sand in the vase and the sand then warms the water to make bubbles in the tube. Besides, the shade is disengageable to facilitate the change of the bulb.

Accordingly, the present invention has a main object to provide a structure of a bed lamp which can warm the colored water in the tube in a very short time and is readily to manufacture.

The present invention will become more fully understood by reference to the following detailed description thereof when read in conjunction with the attached drawings.

### BRIEF DESCRIPTION OF THE DRAWINGS

FIG. 1 is a sectional view to show a bed lamp according to a prior art,

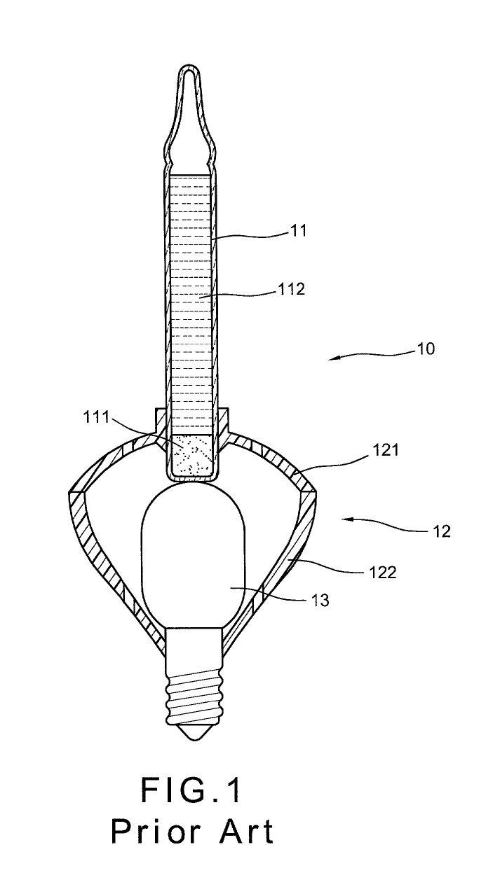

FIG. 2 is an exploded perspective view to show a bed lamp of the preferred embodiment according to the present invention,

FIG. 3 is a perspective view to show the assembly of FIG. 2,

FIG. 4 is a sectional view of FIG. 3,

FIG. 5 is a sectional view to show that the bed lamp of the present invention can be able to engage with a socket from a string of Christmas lights, and

FIG. 6 is a sectional view to show an alternate shade of the present invention.

### DETAILED DESCRIPTION OF THE PREFERRED EMBODIMENT

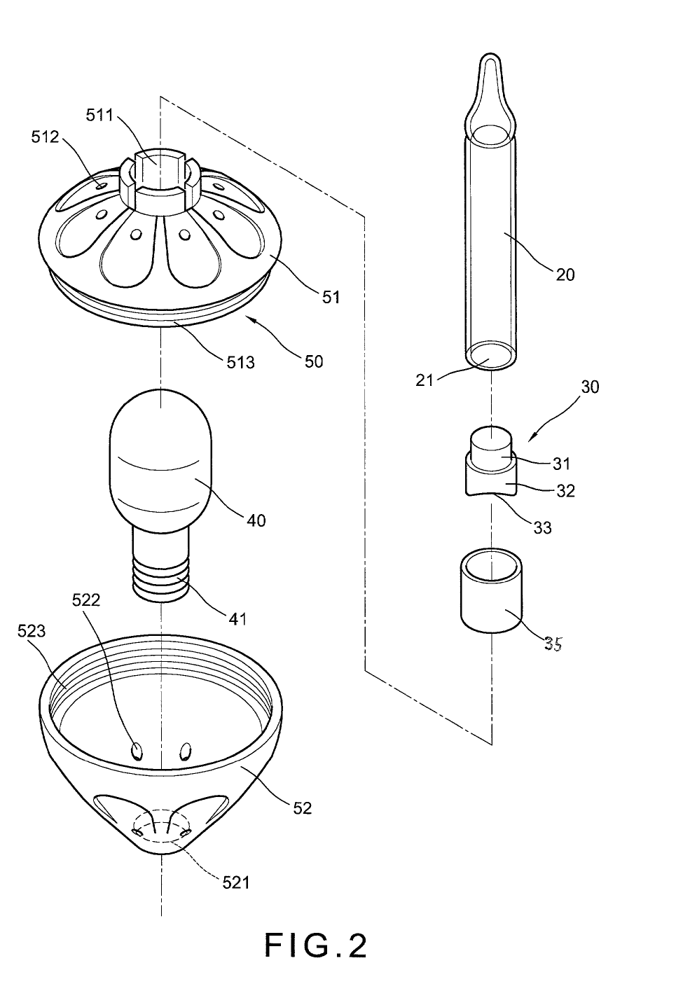

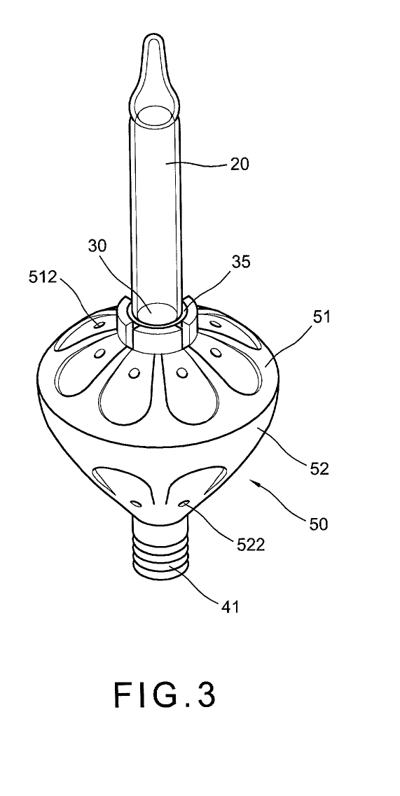

With reference to FIGS. 2, 3 and 4 of the drawings, the structure of a bed lamp of the present invention comprises generally a transparent tube 20, a metal vase 30 and a shade 50.

The transparent tube 20 has an opening 21 in the bottom for pouring the colored water therein.

The metal vase 30 is punched into a sealed off body containing with sand therein and having a reduced upper portion 31 engaged into the opening 21 of the tube 20 secured by adhesives, a depression 33 in the bottom of the body 32. A rubber sleeve 35 wraps the outer periphery between the tube 20 and the metal vase 30.

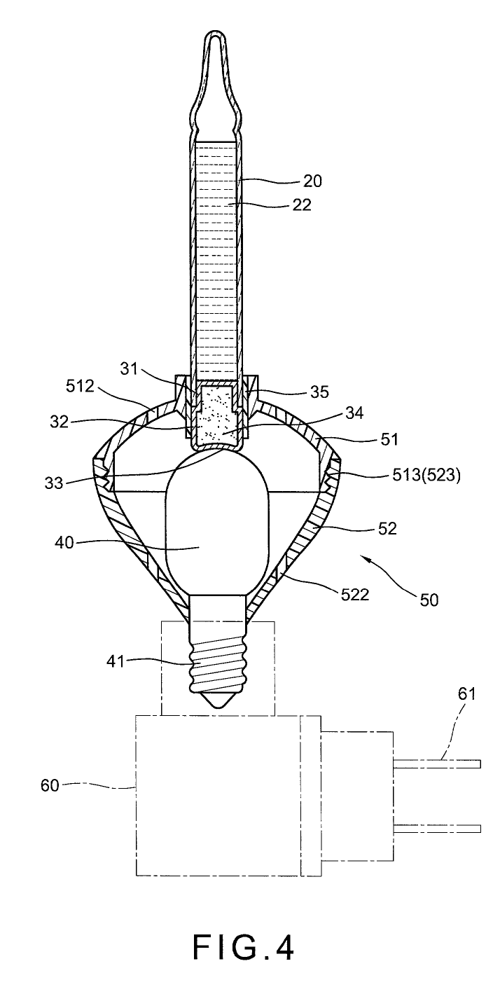

The shade 50 has an upper part 51 and a lower part 52 releasably combined together. The upper part 51 has a protrudent central bore 511 engaged with the metal vase 30 and partial transparent tube 20, a plurality of air vents 512 spacedly formed around the body and a thread 513 on outer periphery of the lower rim. The lower part 52 has a central bore in the bottom to engage with the base 41 of an electric bulb 40, a plurality of air vents 522 spacedly formed around the body and a thread 523 on the inner periphery of the upper rim engageable with the thread 512 of the upper part. The base 41 of the electric bulb 40 projects outward from the bottom of the shade and engages within a socket 60 which has a plug 61 on a lateral side thereof for connecting to a power source. When the metal vase 30 is engaged into the central bore 511, the top of the bulb 40 is engaged within the depression 33 of the vase 30 (as shown in FIG. 4). Because of that the vase 30 is flexible, so the bulb 40 will not be damaged.

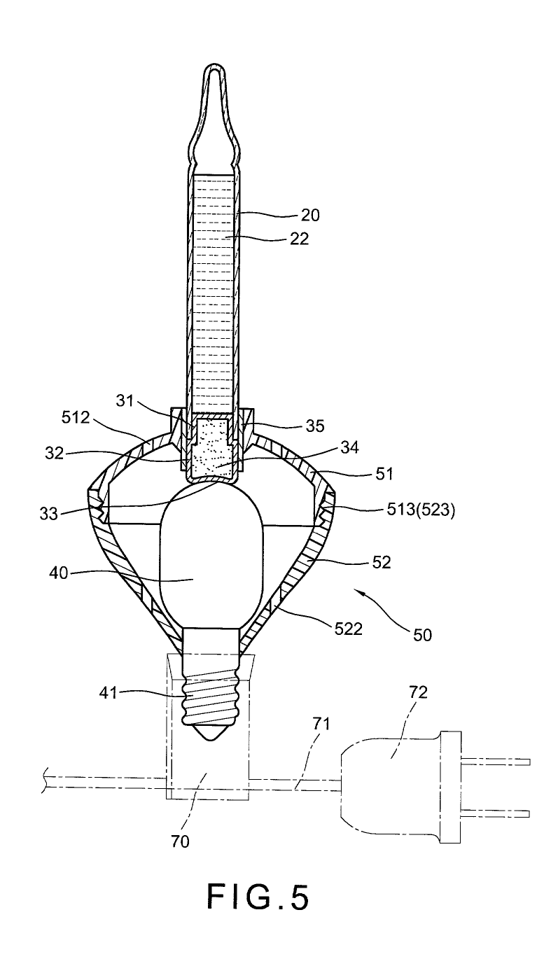

Referring to FIG. 5, the base 41 of the electric bulb 40 may engage with socket 70 of a string of the Christmas light 71 which has also a plug 72 for connecting an power sours.

When the electric bulb 40 is lightened, the heat of the bulb warms the sand in the metal vase 30 and then warms the colored water 22 in the transparent tube 20. When the temperature of the colored water 22 is reached to a certain degree, the bubbles will be created in the transparent tube to pleasant the eye.

The conduction of the heat from the bulb 40 to the colored water 22 is rather rapid because of the entire engagement of the depression 33 of the vase 30 with the top of the electric bulb 40. Because of the shade 50 is disengageable, changing of the bulb 40 is very easier once the bulb is burned out.

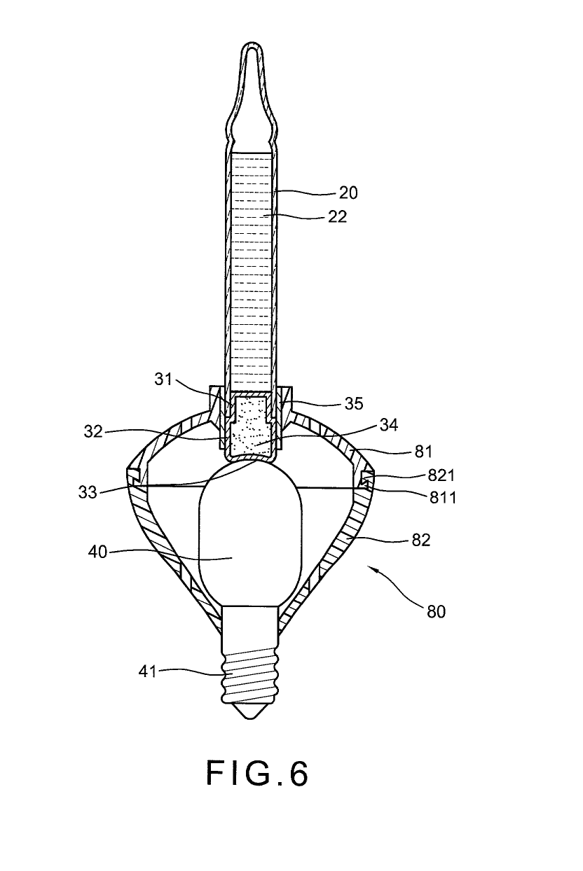

Referring to FIG. 6, an alternate embodiment of the shade 80 is provided. This embodiment is structurally and functionally most similar to the shade 50 as described in FIG. 2. The above discussions are applicable in the most instances. The only difference is that thread 513 and 523 on the upper and lower parts 51 and 52 of the shade 50 is omitted and instead of is a plurality of outward hooked rims 811 on the upper part 81 and a plurality of inward hooked rims 821 on the lower part 82, this changes provides a more rapid disengagement of the upper part 81 with the lower part 82.

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A structure of a bed lamp comprising:
a transparent tube having an opening in bottom for pouring colored water therein;
a circular vase containing sand therein and having a reduced upper portion engaged into the opening of the transparent tube secured with adhesives and a depression in bottom;
a rubber sleeve wrapping on the circular vase and partial transparent tube;
a shade having an upper part having a protrudent central bore engaged with the circular vase and partial transparent tube therein, a plurality of air vents spacedly formed around the protrudent central bore and thread on outer periphery of lower rim; a lower part including a central bore engaged with the base of an electric bulb therein, a plurality of air vents spacedly formed around the central bore and thread in inner periphery of upper rim engaged with the thread of the upper part;
a socket engaged with the base of the electric bulb at outside of the shade and having a plug on a lateral side for connecting an external power sourse.

2. The structure as recited in claim 1 wherein said the base of said electric bulb may engage with a socket from a string of Christmas lights.

3. The structure as recited in claim 1 further has an alternate shade which has a plurality of outward hooked rims on an upper part and a plurality of inward hooked rims on a lower part.
